(19) United States
(12) Patent Application Publication
(10) Pub. No.: US 2025/0240094 A1
(43) Pub. Date: Jul. 24, 2025

(54) OPTICAL TRANSMISSION PATH CHARACTERISTIC ESTIMATION DEVICE

(71) Applicant: Fujitsu Limited, Kawasaki-shi (JP)

(72) Inventors: Setsuo YOSHIDA, Inagi (JP); Shoichiro ODA, Fuchu (JP); Yasuko NOZU, Kawasaki (JP); Kazuyuki TAJIMA, Yokosuka (JP); Shigeru ISHII, Ota (JP); Tatsuya TSUZUKI, Kawasaki (JP); Takehiro FUJITA, Setagaya (JP)

(73) Assignee: Fujitsu Limited, Kawasaki-shi (JP)

(21) Appl. No.: 18/986,269

(22) Filed: Dec. 18, 2024

(30) Foreign Application Priority Data
Dec. 20, 2023 (JP) 2023-214694

(51) Int. Cl. H04B 10/079

(52) U.S. Cl. CPC H04B 10/07957; H04B 10/0793; H04B 10/07955

(57) ABSTRACT

An optical transmission path characteristic estimation device that estimates a polarization characteristic value of an optical path in which first sections that are in service operation of an optical communication service that uses a plurality of wavelengths and second sections that are out of the service operation are mixed, the optical transmission path characteristic estimation device includes a memory, and a processor coupled to the memory and configured to acquire first polarization characteristic values for each of the plurality of wavelengths in the first sections, and acquires second polarization characteristic values for each of the plurality of wavelengths in the second sections, based on information that represent an operation state of the optical communication service, and calculate wavelength-specific polarization characteristic values of the optical path for each of the plurality of wavelengths, based on the first polarization characteristic values and the second polarization characteristic values.

### CROSS-REFERENCE TO RELATED APPLICATION

This application is based upon and claims the benefit of priority of the prior Japanese Patent Application No. 2023-214694, filed on Dec. 20, 2023, the entire contents of which are incorporated herein by reference.

### FIELD

The embodiments discussed herein are related to an optical transmission path characteristic estimation device.

### BACKGROUND

It is known that a multi-level modulation scheme such as quadrature phase shift keying (QPSK) or quadrature amplitude modulation (16QAM) makes selection, using a maximum value of a polarization mode dispersion (PMD) value deduced based on a design value such as a standard value of an optical fiber. In addition, there is also known a technique for calculating a maximum value of the PMD values that fluctuate with time, by multiplying an average value of the PMD values for each wavelength by a predetermined ratio. Note that the ratio of the maximum value to the average value of the PMD values is described, for example, in Table 9-2 of International Telecommunication Union Telecommunication Standardization Sector (ITU-T) Recommendations G.680.

Besides, it is known that the design of the optical fiber transmission path varies in various ways for each project, and it is almost impracticable to prepare a simulated transmission path equivalent to the actual transmission path. In addition, a method of designing an optical fiber transmission path intended to mitigate signal deterioration due to polarization dependent loss (PDL) is also known.

Japanese Laid-open Patent Publication No. 2019-216300, International Publication Pamphlet No. WO 2018/180913, and Japanese Laid-open Patent Publication No. 2012-175607 are disclosed as related arts.

### SUMMARY

According to an aspect of the embodiments, an optical transmission path characteristic estimation device that estimates a polarization characteristic value of an optical path in which first sections that are in service operation of an optical communication service that uses a plurality of wavelengths and second sections that are out of the service operation are mixed, the optical transmission path characteristic estimation device includes a memory, and a processor coupled to the memory and configured to acquire first polarization characteristic values for each of the plurality of wavelengths in the first sections, and acquires second polarization characteristic values for each of the plurality of wavelengths in the second sections, based on information that represent an operation state of the optical communication service, and calculate wavelength-specific polarization characteristic values of the optical path for each of the plurality of wavelengths, based on the first polarization characteristic values and the second polarization characteristic values.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 depicts first exemplary application of an optical network controller;

FIG. 2 depicts an example of a node;

FIG. 3 depicts an example of a hardware configuration of the optical network controller;

FIG. 4 depicts an example of a functional configuration of an optical network controller according to a first embodiment;

FIG. 5 depicts an example of network information;

FIG. 6 is a flowchart illustrating an example of an action of the optical network controller according to the first embodiment;

FIG. 7A depicts an example of PMD value acquisition in ch. 1; FIG. 7B depicts another example of PMD value acquisition in ch. 1;

FIG. 8A depicts an example of PMD value acquisition in ch. N; FIG. 8B depicts another example of PMD value acquisition in ch. N;

FIG. 9 depicts an example of Maxwell distribution;

FIG. 10 is a flowchart illustrating an example of an action of an optical network controller according to a second embodiment;

FIG. 11 is a diagram explaining an example of the number of separate sections out of service operation;

FIG. 12 is a diagram explaining a relationship between wavelength bands and average values of PMD values;

FIG. 13 is a flowchart illustrating an example of an action of an optical network controller according to a third embodiment;

FIG. 14 depicts an example of separate sections as objects for which an average value of PMD values is to be calculated by simple averaging;

FIG. 15 depicts an example of separate sections as objects for which an average value of PMD values is to be calculated with combined sections;

FIG. 16 depicts another example of separate sections as objects for which an average value of PMD values is to be calculated by simple averaging;

FIG. 17 depicts another example of separate sections as objects for which an average value of PMD values is to be calculated with combined sections;

FIG. 18 depicts an example of a functional configuration of an optical network controller according to a fourth embodiment;

FIG. 19 is a flowchart illustrating an example of an action of the optical network controller according to the fourth embodiment;

FIG. 20 is a diagram explaining an example of a goodness of fit test;

FIG. 21 depicts an example of a functional configuration of an optical network controller according to a sixth embodiment;

FIG. 22 is a flowchart illustrating an example of an action of the optical network controller according to the sixth embodiment;

FIG. 23 is a diagram explaining an example of signal types as objects to be selected;

FIG. 24 depicts second exemplary application of an optical network controller;

FIG. 25 depicts an example of a functional configuration of an optical network controller according to a seventh embodiment;

FIG. 26 is a flowchart illustrating an example of an action of the optical network controller according to the seventh embodiment;

FIG. 27 depicts an example of actual measured values of a quality (Q) factor that changes with time;

FIG. 28A depicts an example of distribution of the Q factor; FIG. 28B depicts an example of a relationship between a change amount ΔQ in the Q factor and a transmission penalty ΔOSNR;

FIG. 29 depicts third exemplary application of an optical network controller;

FIG. 30 is a flowchart illustrating an example of an action of an optical network controller according to an eighth embodiment;

FIG. 31A depicts an example of actual measured values of input power that changes with time; FIG. 31B depicts an example of actual measured value of span loss that changes with time; FIG. 31C depicts an example of a corrected Q factor that changes with time;

FIG. 32A depicts an example of a graph illustrating a relationship between span loss and an optical signal to noise ratio (OSNR); FIG. 32B depicts an example of a graph illustrating a relationship between the OSNR and the Q factor; and FIG. 32C depicts an example of a graph illustrating a relationship between the OSNR and the Q factor according to the magnitude of the input power.

### DESCRIPTION OF EMBODIMENTS

In a case where an optical communication service is provided to customers and operated, it may be sometimes difficult to estimate a limit value (such as a maximum value or a worst value, for example) of the polarization characteristic value, such as the PMD value or the PDL value described above, with high accuracy. In an exemplary description, in a case of an optical network in which a plurality of relay nodes is arranged between a transmission node and a reception node, it is rare that the entire transmission section from the transmission node to the reception node is used for the optical communication service. Depending on the customer, for example, a part of the transmission section from the transmission node to a relay node is used for the optical communication service.

In addition, in the optical communication service, different wavelengths are allocated to each customer. For this reason, in some cases, a part of transmission section may be used for a customer to which a particular wavelength is allocated, and another part of transmission section may be used for another customer to which another wavelength different from the particular wavelength is allocated. In this manner, in the optical communication service using a plurality of wavelengths, an in-operation section in which the optical communication service is in operation and an out-of-operation section in which the optical communication service is not in operation are mixed.

In a case where the in-operation section and the out-of-operation section are mixed, it is difficult to carry out the wavelength sweep for all the wavelengths that can be allocated to the customers end-to-end from the transmission node to the reception node. Accordingly, the polarization characteristic value may not be acquired by the wavelength sweep, and it is hard to estimate the limit value of the polarization characteristic value. In addition, measuring instruments for measuring the PMD value are provided in the relay node and the reception node, but it is hard to measure the PMD value by the measuring instruments because the wavelength characteristics are not allowed to be measured in the out-of-operation section.

Besides, the polarization characteristic value that randomly changes with time, such as the PMD value or the PDL value, may sometimes have a large measurement error even when measured by the measuring instruments, and even when a transmission penalty (amount of deterioration) that fluctuates with time is estimated based on the measured values, estimation accuracy may be possibly low.

Thus, in one aspect, an object is to provide an optical transmission path characteristic estimation device, an optical transmission system, and a method for estimating an optical transmission path characteristic that estimate a characteristic value of an optical transmission path attributable to a polarization characteristic.

Hereinafter, modes for carrying out the present case will be described with reference to the drawings.

### First Embodiment

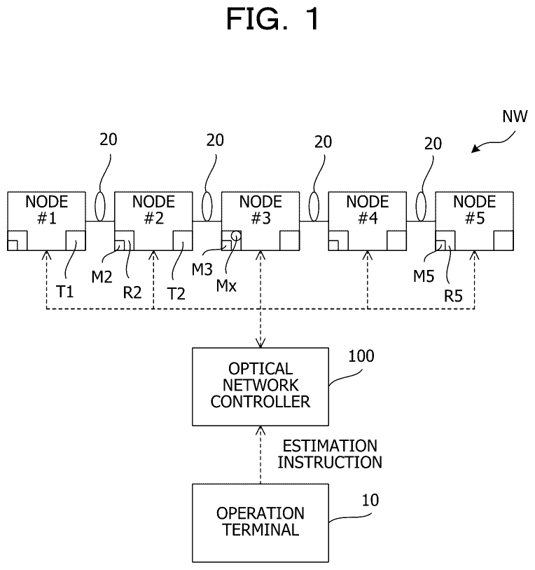

As illustrated in FIG. 1, an optical network NW includes a plurality of nodes #1, . . . , and #5. The nodes #1, . . . , and #5 include, for example, reconfigurable optical add-drop multiplexer (ROADM) devices. For example, the node #1 is arranged at one end of the optical network NW, and the node #5 is arranged at another end of the optical network NW. The nodes #2, . . . , and #4 are arranged as relay nodes between the node #1 and the node #5.

The node #2 is coupled to the adjacent nodes #1 and #3 via an optical fiber 20. Since the coupling forms of the nodes #3 and #4 are basically similar to the coupling form of the node #2, detailed description thereof will be omitted. The node #2 includes an optical receiver R2 that receives signal light (for example, wavelength-multiplexed signal light) and an optical transmitter T2 that transmits signal light.

The optical receiver R2 includes a measuring instrument M2 that measures a differential group delay (DGD) in PMD as a PMD value. The PMD value is an example of the polarization characteristic value. Instead of the PMD value, the PDL value may be adopted as the polarization characteristic value. Note that the DGD may be sometimes referred to as an amount of primary PMD. The configurations of the node #1 and the nodes #3, . . . , and #5 are basically similar to the configuration of the node #2. Accordingly, for example, the node #1 includes an optical transmitter T1. In addition, the node #5 includes an optical receiver R5 including a measuring instrument M5. Note that a node #3 including another measuring instrument Mx that measures a polarization fluctuation speed, together with the measuring instrument M3, may be sometimes included in the optical network NW.

The optical network controller 100 controls actions of a plurality of nodes #1, . . . , and #5, based on an estimation instruction issued from an operation terminal 10. As will be described in detail later, the optical network controller 100 acquires the PMD value from at least one of the nodes #1, . . . , or #5 when detecting the estimation instruction. When acquiring the PMD value, the optical network controller 100 then estimates a worst value (or a maximum value) that is a limit value of the PMD value of an optical transmission path corresponding to the entire transmission section from one end to another end of the optical network NW, based on the acquired PMD value.

This may enable to specify that the worst value is excessive, based on the actual measurement of the PMD value, even if the excessive PMD value has been deduced as the worst value, based on the design value of the optical transmission path. Accordingly, in a case where the worst value is found to be excessive, the optical network controller 100 may be allowed to select and use an appropriate signal type (in terms of a modulation scheme, a transmission capacity, a baud rate, and the like, for example), based on the estimated worst value.

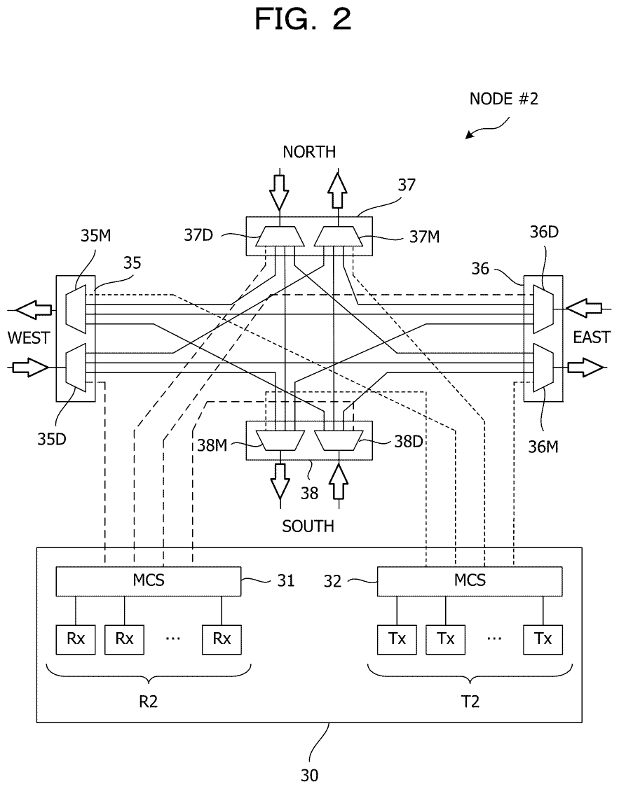

Details of the node #2 will be described with reference to FIG. 2. Note that the node #1 and the nodes #3, . . . , and #5 have configurations similar to the configuration of the node #2, and thus detailed description thereof will be omitted. The node #2 includes an optical transmission-reception unit 30 and a plurality of wavelength selection units 35, . . . , and 38. The optical transmission-reception unit 30 includes the optical receiver R2 and the optical transmitter T2 described above, and N×M (both of N and M denote natural numbers) multicast switches (MCSs) 31 and 32. Instead of the MCSs 31 and 32, N×M wavelength selective switches (WSSs) or other devices may be adopted, but the optical devices have to have a colorless-directionless-contentionless (CDC) function. This is to implement measurement of the polarization characteristic value with a desired route and a desired wavelength by one available optical transceiver that communicates no signal.

The optical receiver R2 includes a plurality of digital coherent receivers Rx. Although not illustrated, the digital coherent receiver Rx includes a wavelength-tunable light source whose wavelength (hereinafter, also referred to as a channel as appropriate) can be set by the optical network controller 100, together with the measuring instrument M2 described above. Each of the digital coherent receivers Rx is coupled to the MCS 31. The optical transmitter T2 includes a plurality of digital coherent transmitters Tx. Although not illustrated, the digital coherent transmitter Tx includes a wavelength-tunable light source whose wavelength can be set by the optical network controller 100. Each of the digital coherent transmitters Tx is coupled to the MCS 32.

The wavelength selection unit 35 includes WSSs 35M and 35D. The wavelength selection unit 36 includes WSSs 36M and 36D. The wavelength selection unit 37 includes WSSs 37M and 37D. The wavelength selection unit 38 includes WSSs 38M and 38D.

The WSSs 35M, 36M, 37M, and 38M are all coupled to the MCS 32. The WSSs 35M, 36M, 37M, and 38M multiplex input rays of wavelength light having different wavelengths according to setting and output the multiplexed light as signal light. For example, the WSS 36M multiplexes the wavelength light input from the MCS 32 and the wavelength light input from the WSSs 35D, 37D, and 38D and outputs the multiplexed light to the adjacent node #3 as signal light.

The WSSs 35D, 36D, 37D, and 38D are all coupled to the MCS 31. The WSSs 35D, 36D, 37D, and 38D demultiplex input signal light into rays of wavelength light having different wavelengths according to setting and output the demultiplexed signal light. For example, the WSS 35D demultiplexes the signal light transmitted and input from the adjacent node #1 into rays of wavelength light having different wavelengths, outputs some rays of the wavelength light to the MCS 31, and outputs the remainder rays of the wavelength light to any one of the WSSs 36M, 37M, and 38M.

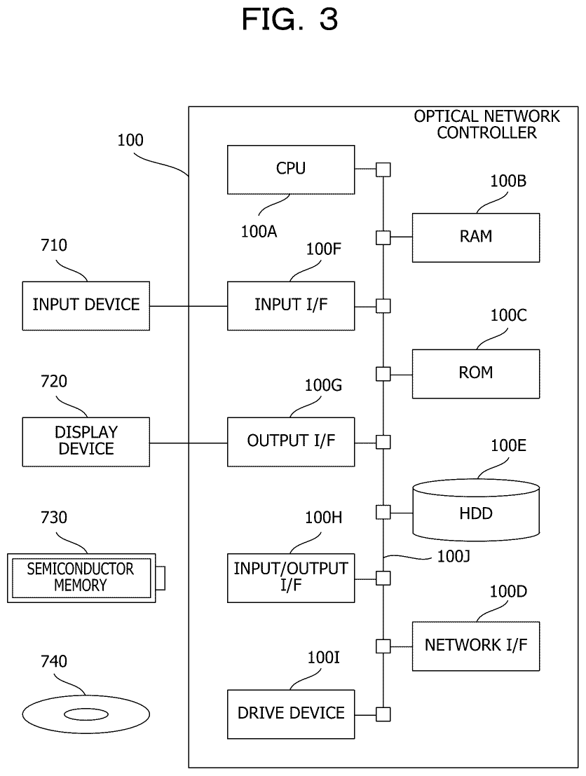

A hardware configuration of the optical network controller 100 will be described with reference to FIG. 3.

The optical network controller 100 includes a central processing unit (CPU) 100A as a processor, and a random access memory (RAM) 100B and a read only memory (ROM) 100C as memories. The optical network controller 100 includes a network interface (I/F) 100D and a hard disk drive (HDD) 100E. A solid state drive (SSD) may be adopted instead of the hard disk drive (HDD) 100E.

The optical network controller 100 may include at least one of an input I/F 100F, an output I/F 100G, an input/output I/F 100H, or a drive device 100I, if desired. The CPU 100A to the drive device 100I are coupled to each other by an internal bus 100J. For example, the optical network controller 100 can be implemented by a computer.

An input device 710 is coupled to the input I/F 100F. Examples of the input device 710 include a keyboard, a mouse, a touch panel, and the like. A display device 720 is coupled to the output I/F 100G. Examples of the display device 720 include a liquid crystal display and the like. A semiconductor memory 730 is coupled to the input/output I/F 100H. Examples of the semiconductor memory 730 include a universal serial bus (USB) memory, a flash memory, and the like. The input/output I/F 100H reads an optical transmission path characteristic estimation program stored in the semiconductor memory 730. The input I/F 100F and the input/output I/F 100H include, for example, USB ports. The output I/F 100G includes, for example, a display port.

A portable recording medium 740 is inserted into the drive device 100I. Examples of the portable recording medium 740 include a removable disk such as a compact disc (CD)-ROM or a digital versatile disc (DVD). The drive device 100I reads the optical transmission path characteristic estimation program recorded in the portable recording medium 740. For example, the network I/F 100D includes a local area network (LAN) port, a communication circuit, and the like. The communication circuit includes one or both of a wired communication circuit and a wireless communication circuit. The network I/F 100D is coupled to the operation terminal 10 and the nodes #1, . . . , and #5.

The optical transmission path characteristic estimation program stored in at least one of the ROM 100C, the HDD 100E, or the semiconductor memory 730 is temporarily stored in the RAM 100B by the CPU 100A. The optical transmission path characteristic estimation program recorded in the portable recording medium 740 is temporarily stored in the RAM 100B by the CPU 100A. With the stored optical transmission path characteristic estimation program being executed by the CPU 100A, the CPU 100A implements various functions to be described later and also executes a method for estimating an optical transmission path characteristic including various processes to be described later. Note that the optical transmission path characteristic estimation program only has to be in line with flowcharts to be described later.

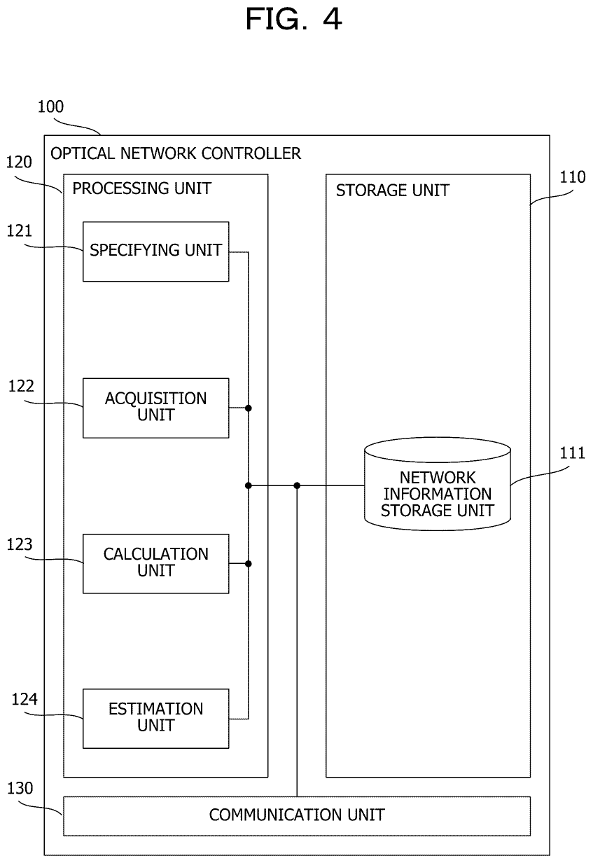

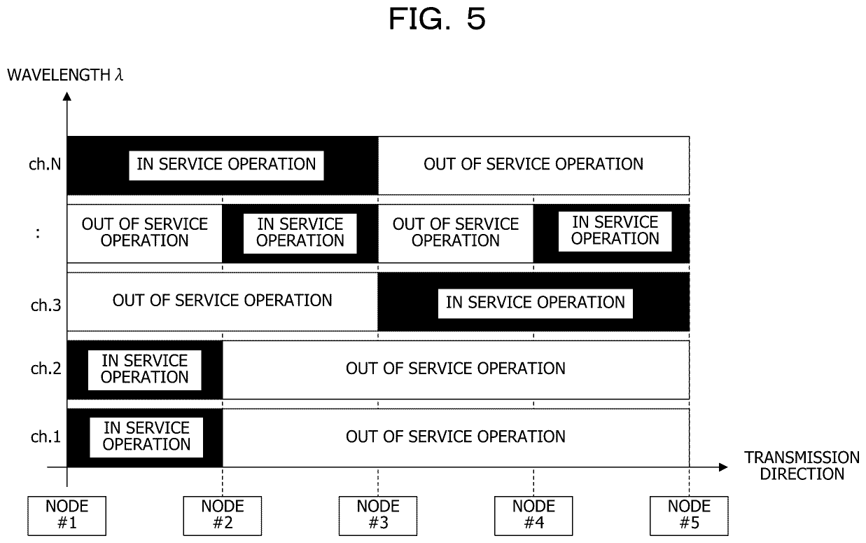

A functional configuration of the optical network controller 100 according to the first embodiment will be described with reference to FIGS. 4 and 5.

As illustrated in FIG. 4, the optical network controller 100 includes a storage unit 110, a processing unit 120, and a communication unit 130. The storage unit 110 can be implemented by one or both of the RAM 100B and the HDD 100E described above. The processing unit 120 can be implemented by the CPU 100A described above. The communication unit 130 can be implemented by the network I/F 100D described above.

The storage unit 110, the processing unit 120, and the communication unit 130 are coupled to each other. The storage unit 110 includes a network information storage unit 111. The processing unit 120 includes a specifying unit 121, an acquisition unit 122, a calculation unit 123, and an estimation unit 124.

The network information storage unit 111 stores network information. As illustrated in FIG. 5, the network information represents an operation state of an optical communication service using the optical network NW. For example, a wavelength λ represents any wavelength in a conventional band (C-band) that is a wavelength band of 1530 nanometers (nm) to 1565 nm. Instead of the C-band, a wavelength in a long band (L-band) that is a wavelength band having a long wavelength of 1565 nm to 1625 nm may be adopted for the wavelength λ.

In channel 1 (ch. 1), which is the lowest wavelength of the C-band, the separate section from the node #1 to the node #2 in the transmission section from the node #1 to the node #5 is used to provide the optical communication service to a customer. Therefore, the separate section from the node #1 to the node #2 corresponds to an in-service operation section. The in-service operation section is an example of a first section.

Meanwhile, the separate section from the node #2 to the node #5 is not used. For example, the optical communication service is not provided to the customer in this separate section. Therefore, the separate section from the node #2 to the node #5 corresponds to an out-of-service operation section. The out-of-service operation section is an example of a second section. Since ch. 2 to ch. N are basically similar to ch. 1, detailed description thereof will be omitted. In this manner, the network information storage unit 111 stores the network information in which the in-service operation section and the out-of-service operation section are mixed.

Returning to FIG. 4, when detecting the estimation instruction issued from the operation terminal 10, the specifying unit 121 then refers to the network information to specify all channels from ch. 1 to ch. N used in the optical network NW. When specifying all the channels from ch. 1 to ch. N, the specifying unit 121 then selects any one of the channels from among ch. 1 to ch. N and specifies a measurement section for the PMD. For example, in a case where ch. 1 is selected, the specifying unit 121 specifies the in-service operation section from the node #1 to the node #2 and the out-of-service operation section from the node #2 to the node #5.

When specifying the in-service operation section and the out-of-service operation section in the selected ch. 1, the specifying unit 121 then similarly specifies the in-service operation sections and the out-of-service operation sections in remaining ch. 2 to ch. N. This ensures that the specifying unit 121 specifies all in-service operation sections and all out-of-service operation sections.

The acquisition unit 122 acquires the PMD value. For example, in the in-service operation section from node #1 to node #2 in ch. 1, the node #2 receives the signal light transmitted from the node #1. Therefore, the acquisition unit 122 can acquire the PMD value from the measuring instrument M2 of the node #2. Meanwhile, in the out-of-service operation section from the node #2 to the node #5 in ch. 1, no signal light is propagated. Therefore, the acquisition unit 122 temporarily sets (or stretches) the optical path in ch. 1 in the out-of-service operation section from the node #2 to the node #5. This allows the node #5 to receive the signal light transmitted from the node #2, and the acquisition unit 122 can acquire the PMD value from the measuring instrument M5 of the node #5.

The calculation unit 123 calculates an average value of the PMD values. For example, in a case where ch. 1 is specified, the calculation unit 123 calculates a square root of a sum of the square of a first PMD value that is a PMD value acquired from the measuring instrument M2, and the square of a second PMD value that is a PMD value acquired from the measuring instrument M5, as a wavelength-specific average value of the PMD values. The calculation unit 123 calculates the wavelength-specific average values of the PMD values for each channel from ch. 2 to ch. N, similarly to ch. 1. For example, the calculation unit 123 calculates N wavelength-specific average values of the PMD values corresponding to the number of channels. When calculating the N wavelength-specific average values, the calculation unit 123 then divides the total sum of the N wavelength-specific average values by the number of channels. For example, the calculation unit 123 calculates a simple average (or an arithmetic average) of the N wavelength-specific average values. This allows the calculation unit 123 to calculate an average value of the PMD values of the nodes #1 to #5.

The estimation unit 124 estimates the worst value of the PMD values as a constant k times the average value of the PMD values, based on Maxwell distribution in which the occurrence probability of the worst value of the PMD values is fixed, and the average value of the PMD values. The constant k corresponds to the ratio of the maximum value to the average value of the PMD values described in Table 9-2 of ITU-T Recommendations G.680 (see also Japanese Laid-open Patent Publication No. 2019-216300 mentioned above). Note that details of the Maxwell distribution and the like used when the estimation unit 124 estimates the worst value of the PMD values will be described later.

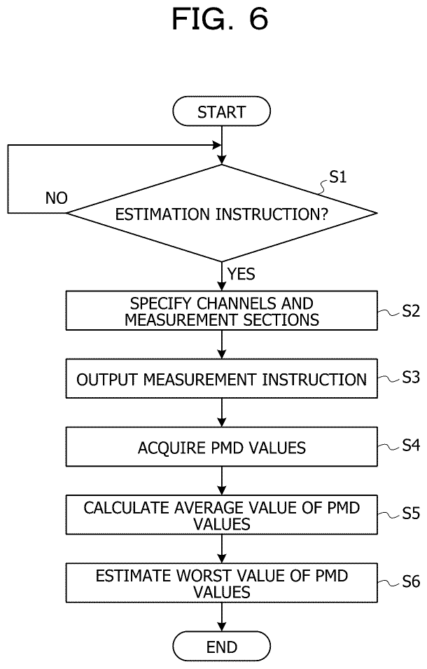

An action of the optical network controller 100 according to the first embodiment will be described with reference to FIGS. 6 to 9.

First, as illustrated in FIG. 6, the specifying unit 121 waits until an estimation instruction is detected (step S1: NO). The estimation instruction is an instruction intended to request the optical network controller 100 to estimate the worst value of the PMD values. When detecting the estimation instruction (step S1: YES), the specifying unit 121 then specifies the channels and the measurement sections (step S2). For example, the specifying unit 121 refers to the network information to specify all channels from ch. 1 to ch. N used in the optical network NW. In addition, when specifying all the channels from ch. 1 to ch. N, the specifying unit 121 then specifies the in-service operation sections and the out-of-service operation sections for each channel from ch. 1 to ch. N as the measurement sections.

When specifying the channels and the measurement sections, the specifying unit 121 then outputs a measurement instruction (step S3). The measurement instruction is an instruction intended to request the measuring instrument M2, the measuring instrument M5, and the like to measure the PMD values. For example, in a case where all the channels from ch. 1 to ch. N have been specified, the specifying unit 121 selects ch. 1 having the minimum wavelength and also selects the in-service operation section and the out-of-service operation section in selected ch. 1. In the present embodiment, the specifying unit 121 selects the separate section from the node #1 to the node #2 as the in-service operation section. In addition, the specifying unit 121 selects the separate section from the node #2 to the node #5 as the out-of-service operation section.

When selecting ch. 1 and the in-service operation section, the specifying unit 121 then outputs the measurement instruction to a measuring instrument of a terminal node located at a terminal end of the in-service operation section. In the present embodiment, the specifying unit 121 outputs the measurement instruction to the measuring instrument M2 of the node #2 located at the terminal end of the in-service operation section.

In addition, when selecting ch. 1 and the out-of-service operation section, the specifying unit 121 then sets ch. 1 in one of the digital coherent transmitters Tx included in the optical transmitter T2 of the node #2 and sets ch. 1 in one of the digital coherent receivers Rx included in the optical receiver R5 of the node #5. After the setting, the specifying unit 121 temporarily sets a logical optical path in the out-of-service operation section from the node #2 to the node #5. When setting the optical path, the specifying unit 121 then outputs the measurement instruction to a measuring instrument of a terminal node located at a terminal end of the out-of-service operation section. In the present embodiment, the specifying unit 121 outputs the measurement instruction to the measuring instrument M5 of the node #5 located at the terminal end of the out-of-service operation section.

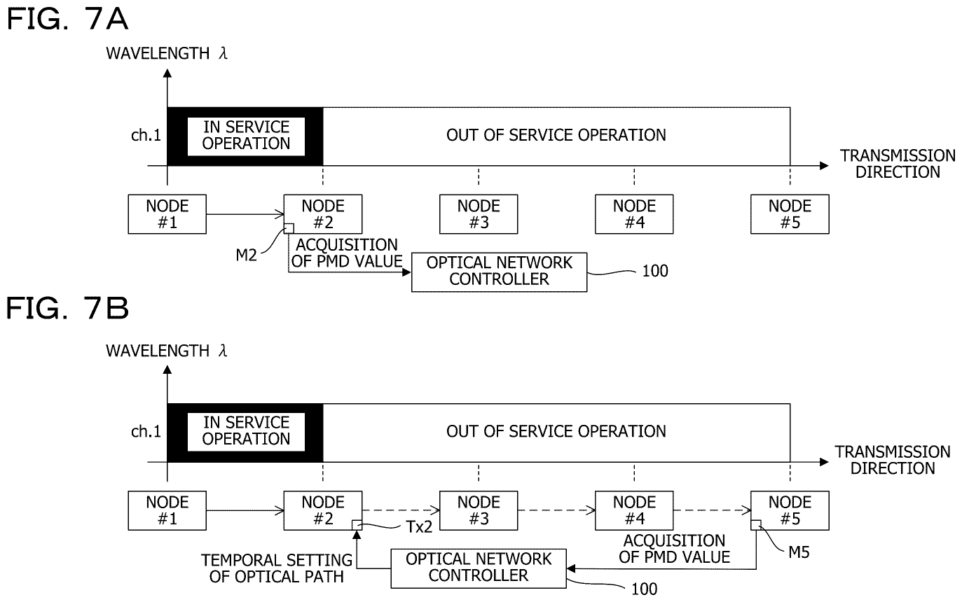

When the specifying unit 121 outputs the measurement instruction, the acquisition unit 122 then acquires the PMD values (step S4). As described above, in a case where the specifying unit 121 outputs the measurement instruction to the measuring instrument M2 of the node #2, the acquisition unit 122 acquires the PMD value from the measuring instrument M2 as illustrated in FIG. 7A. In a case where the specifying unit 121 outputs the measurement instruction to the measuring instrument M5 of the node #5, the acquisition unit 122 acquires the PMD value from the measuring instrument M5 as illustrated in FIG. 7B. In a case where the specifying unit 121 sets an optical path in the out-of-service operation section, the acquisition unit 122 deletes the optical path after acquiring the PMD values and returns the out-of-service operation section to the original waiting state before the optical path setting.

When the acquisition unit 122 acquires the PMD values, the calculation unit 123 then calculates an average value of the PMD values (step S5). For example, as described above, in a case where the acquisition unit 122 acquires the first PMD value that is a PMD value in the in-service operation section and the second PMD value that is a PMD value in the out-of-service operation section in ch. 1, the calculation unit 123 calculates the wavelength-specific average value of the PMD values in ch. 1 by the following mathematical formula. This ensures that the average value of the PMD values in the transmission section from node #1 to node #5 in ch. 1 is calculated.

Wavelength-Specific Average Value=√((First PMD Value)²+(Second PMD Value)²) <Mathematical Formula>

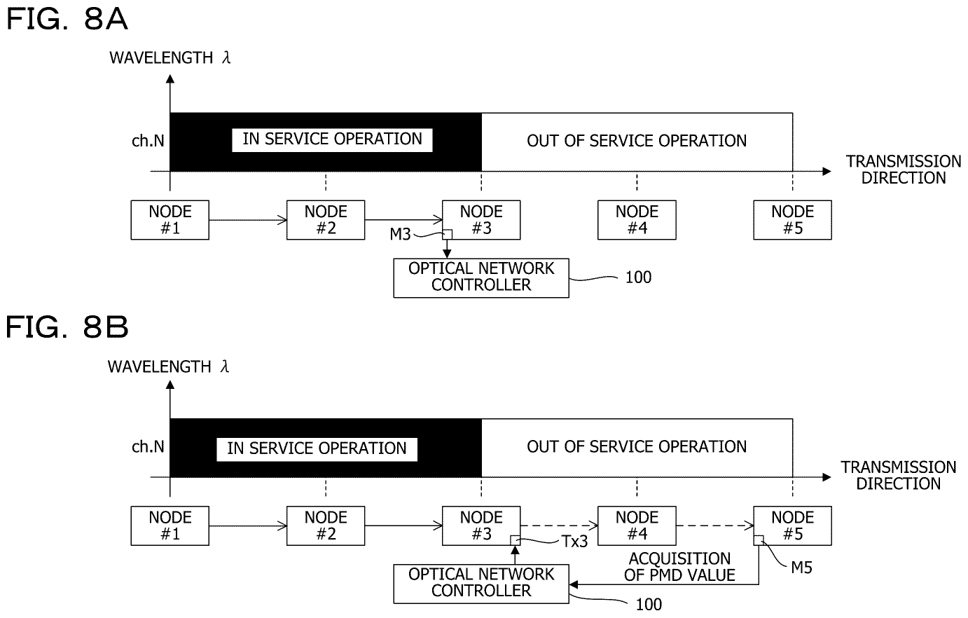

When the calculation unit 123 calculates the wavelength-specific average value of the PMD values in ch. 1, the wavelength-specific average values of the PMD values are then calculated for ch. 2 to ch. N, similarly to ch. 1. For example, in a case where the specifying unit 121 selects ch. N having the maximum wavelength and outputs the measurement instruction to the measuring instrument M3 of the node #3, the acquisition unit 122 acquires the PMD value from the measuring instrument M3 as illustrated in FIG. 8A. In a case where the specifying unit 121 outputs the measurement instruction to the measuring instrument M5 of the node #5, the acquisition unit 122 acquires the PMD value from the measuring instrument M5 as illustrated in FIG. 8B. This allows the calculation unit 123 to calculate the wavelength-specific average value of the PMD values in ch. N. In this manner, for the transmission section from the node #1 to the node #5, the calculation unit 123 not only calculates the wavelength-specific average value of the PMD values in ch. 1, but also calculates the wavelength-specific average values of the PMD values in all of ch. 2 to ch. N.

When calculating the wavelength-specific average values of the PMD values of all the channels from ch. 1 to ch. N for the transmission section from the node #1 to the node #5, the calculation unit 123 then calculates an average value (for example, a total average value) of the PMD values. For example, the calculation unit 123 calculates a simple average of the N wavelength-specific average values. This allows the calculation unit 123 to calculate the average value of the PMD values in the transmission section from the node #1 to the node #5.

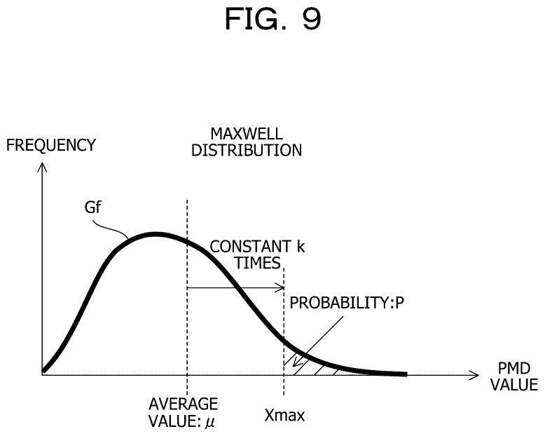

When the average value of the PMD values is calculated, the estimation unit 124 then estimates the worst value of the PMD values (step S6) and ends the process. Here, as illustrated in FIG. 9, the estimation unit 124 estimates a worst value Xₘₐₓ of the PMD values, based on an average value u of the PMD values and Maxwell distribution in which a probability P of occurrence of the worst value of the PMD values of the optical transmission path is fixed. Here, in a case where the PMD value fluctuates with time due to a swing in the optical transmission path (such as polarization rotation by the optical fiber 20, for example), its statistical distribution (probability density distribution) can be theoretically approximated to the Maxwell distribution.

The Maxwell distribution has a property that the curve shape of a cumulative distribution function Gf is uniquely defined when the average value u of the PMD values is designated. In addition, the Maxwell distribution has a property that, when the probability P is fixed, the value of an inverse function of a survival function of the Maxwell distribution (for example, the worst value Xₘₐₓ of the PMD values) has a constant multiple of the average value u. Using these properties, the estimation unit 124 simply estimates the worst value of the PMD values in the transmission section from the node #1 to the node #5, as a constant k times the average value μ (such as k=3, for example).

As described above, the optical network controller 100 according to the first embodiment may estimate the worst value of the PMD values of the optical transmission path from the node #1 to the node #5 even if the in-service operation section and the out-of-service operation section are mixed.

### Second Embodiment

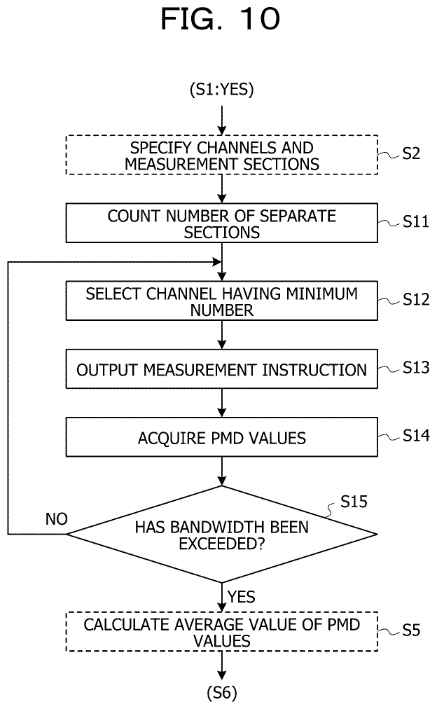

Subsequently, a second embodiment of the present case will be described with reference to FIGS. 10 to 12. Note that, in FIG. 10, some processes overlapping with the flowchart illustrated in FIG. 6 are omitted. This similarly applies to the flowcharts of embodiments to be described later as well. In the second embodiment, the number of calculated average values of the PMD values is reduced by limiting the channels selected by a specifying unit 121. This ensures that, for example, the processing load of a CPU 100A is lessened and the power consumption of an optical network controller 100 is suppressed.

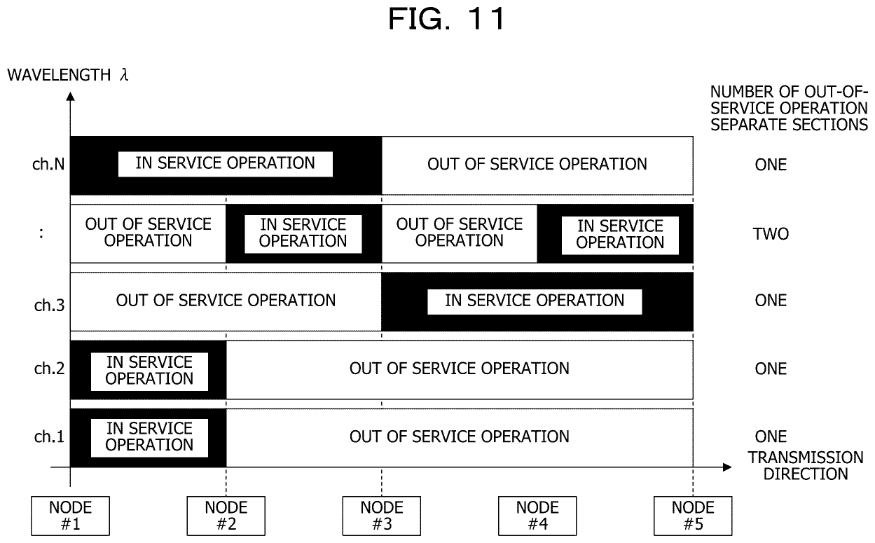

First, as illustrated in FIG. 10, when ending the process in step S2, the specifying unit 121 then counts the number of separate sections (step S11). For example, as illustrated in FIG. 11, the specifying unit 121 counts the number of separate sections out of service operation individually for all the specified channels from ch. 1 to ch. N. For example, the specifying unit 121 counts the number of separate sections as one for ch. 1. In addition, the specifying unit 121 counts the number of separate sections as two for any one of ch. 4 to ch. N-1 (not illustrated).

When counting the number of separate sections, the specifying unit 121 then selects a channel having a minimum number (step S12). In the present embodiment, since the minimum number of separate sections is one, for example, the specifying unit 121 selects ch. 1 having the minimum wavelength. Note that the specifying unit 121 may select ch. N having the maximum wavelength. When selecting the channel having a minimum number, the specifying unit 121 then outputs the measurement instruction similarly to the process in step S3 (step S13). This ensures that an acquisition unit 122 acquires the PMD values similarly to the process in step S4 (step S14). For example, in a case where the specifying unit 121 selects ch. 1, the acquisition unit 122 acquires the PMD values from each of the measuring instruments M2 and M5.

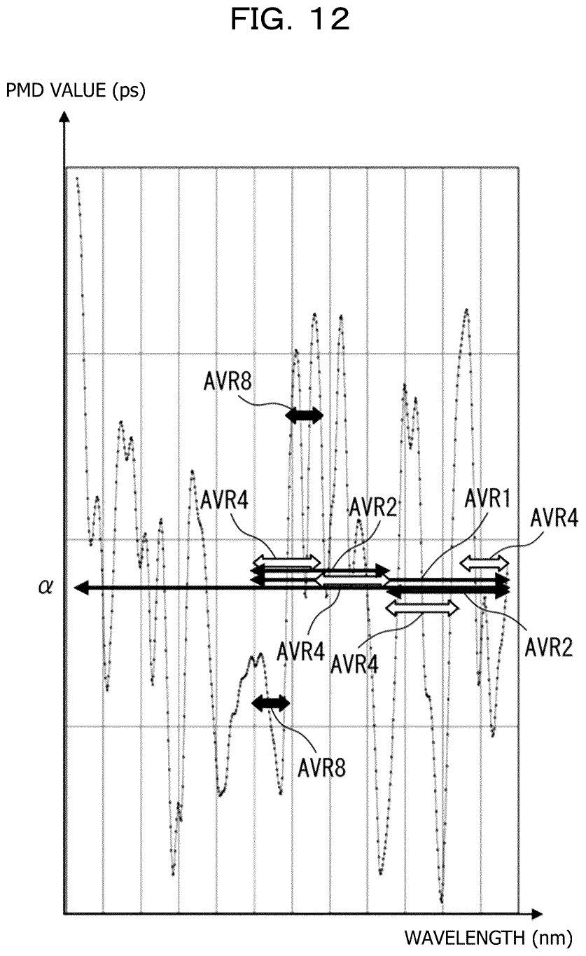

Here, the specifying unit 121 determines whether or not a predetermined threshold bandwidth has been exceeded (step S15). For example, in a case when the channels from ch. 1 to ch. N correspond to the C-band, ⅛ of the C-band can be adopted as the predetermined threshold bandwidth. As illustrated in FIG. 12, in a case where an average value AVR1 of the PMD values of the entire C-band, an average value AVR2 of the PMD values of ½ of the C-band, and an average value AVR4 of the PMD values of ¼ of the C-band are calculated, the calculated average values AVR1, AVR2, and AVR4 stay around a particular numerical value a.

Meanwhile, in a case where an average value AVR8 of the PMD values of ⅛ of the C-band is calculated, a large variation occurs. For example, when a value less than ⅛ of the C-band is adopted, the calculation accuracy for the average value of the PMD values may be likely to be lowered. Therefore, in the second embodiment, the specifying unit 121 determines whether or not ⅛ of the C-band has been exceeded. This suppresses lowering of the calculation accuracy for the average value of the PMD values.

In a case where the predetermined threshold bandwidth is not exceeded (step S15: NO), the specifying unit 121 repeats the processes in steps S12 to S14. This prompt, for example, the specifying unit 121 to select ch. 2 having the next minimum wavelength, of which the number of separate sections is one, and the acquisition unit 122 acquires the PMD values. For example, in a case where the specifying unit 121 selects ch. 2, the acquisition unit 122 acquires the PMD values from each of the measuring instruments M2 and M5. In this manner, the processes in steps S12 to S14 are repeated until the predetermined threshold bandwidth is exceeded.

Then, in a case where the predetermined threshold bandwidth is exceeded (step S15: YES), the calculation unit 123 executes the processes in steps S5 and S6, similarly to the first embodiment. This ensures that the worst value of the PMD values is estimated. As described above, according to the second embodiment, even if the channels to be selected are limited to some channels, the optical network controller 100 may accurately estimate the worst value of the PMD values.

### Third Embodiment

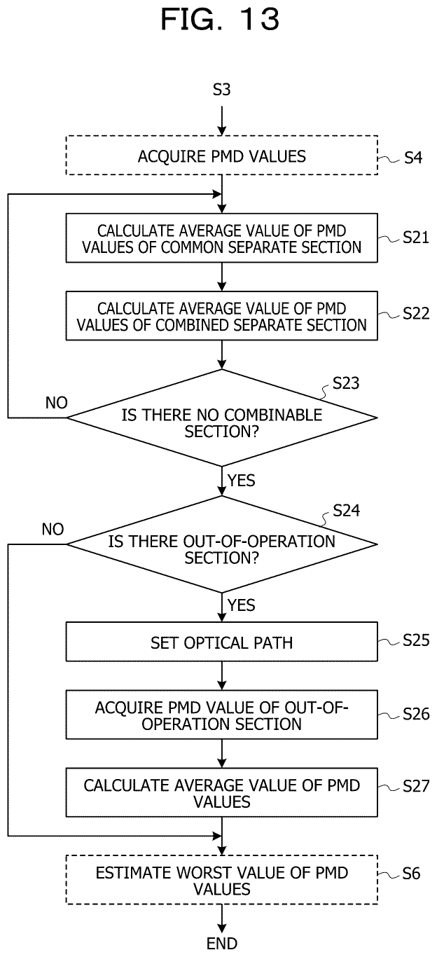

Subsequently, a third embodiment of the present case will be described with reference to FIGS. 13 to 17. An optical network controller 100 according to the third embodiment can estimate the worst value of the PMD values while avoiding the optical path setting described in the first embodiment. This may avoid, for example, the use of digital coherent receivers Rx and digital coherent transmitters Tx and may suppress short lives of the digital coherent receivers Rx and the digital coherent transmitters Tx.

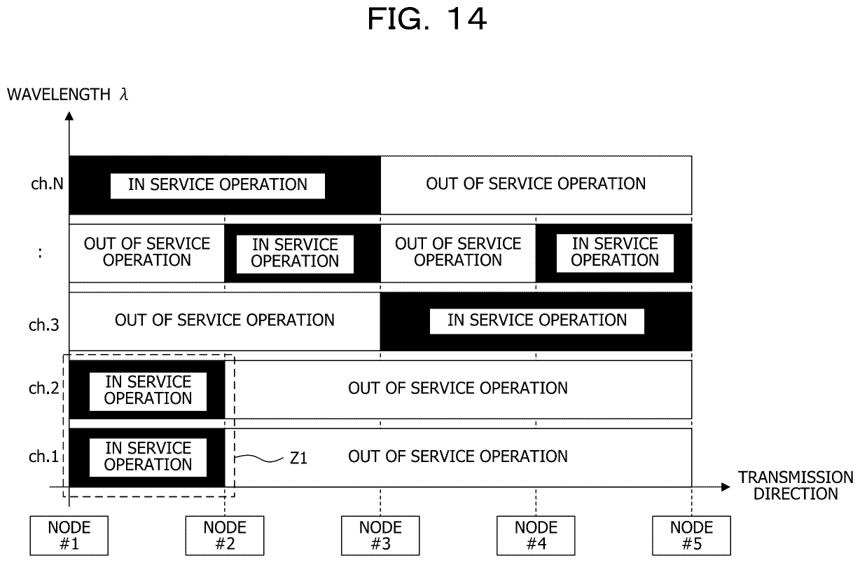

First, as illustrated in FIG. 13, when an acquisition unit 122 executes the process in step S4, a calculation unit 123 then calculates an average value of the PMD values of a common separate section (step S21). The average value of the PMD values of the common separate section is an example of a first polarization characteristic average value. For example, as illustrated in FIG. 14, a separate section Z1 from a node #1 to a node #2, which is an in-service operation section, is common to ch. 1 and ch. 2. Here, the acquisition unit 122 acquires the PMD value of ch. 1 and the PMD value of ch. 2 from a measuring instrument M2 of the node #2 by the process in step S4. Therefore, the calculation unit 123 calculates a simple average of these two PMD values as an average value of the PMD values.

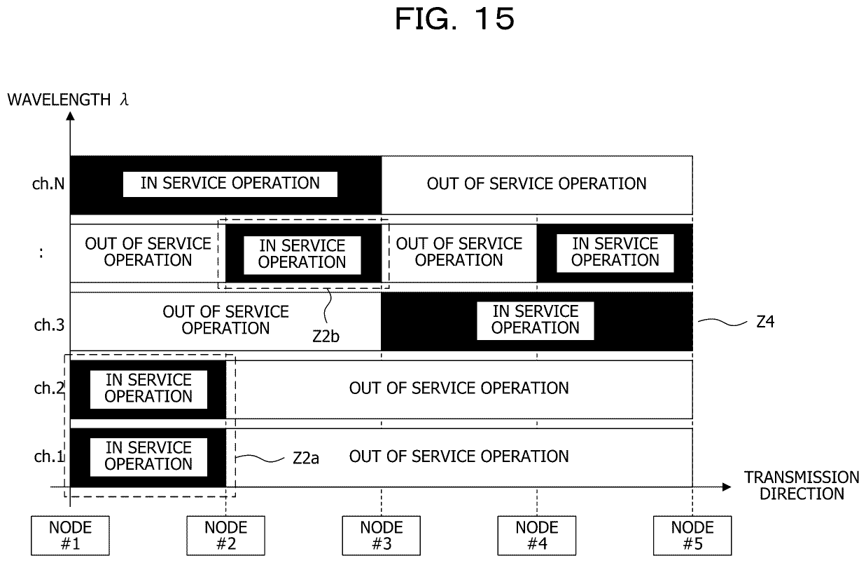

When calculating the average of the PMD values of the common separate section, the calculation unit 123 then calculates an average value of the PMD values of a combined separate section (step S22). The average value of the PMD values of the combined separate section is an example of a second polarization characteristic average value. For example, as illustrated in FIG. 15, the calculation unit 123 specifies, as the combined separate section, separate sections Z2a and Z2b that do not have overlapping channels and are adjacent to each other as in-service operation sections. When specifying the combined separate section, the calculation unit 123 then calculates a square root of a sum of the square of the average value of the separate section Z2a and the square of the PMD value of the separate section Z2b. The calculation unit 123 treats this calculated square root as the average value of the PMD values of the combined separate section.

When calculating the average value of the PMD values of the combined separate section, the calculation unit 123 then determines whether or not there is no combinable section (step S23). For example, it is determined whether or not there are no separate sections that do not have overlapping channels and are adjacent to each other as in-service operation sections. For example, as illustrated in FIG. 15, in a case where there is a separate section Z4 that does not have an overlapping channel and is one of in-service operation sections adjacent to each other, the calculation unit 123 determines that there is a combinable section (step S23: NO). In this case, the calculation unit 123 repeats the processes in steps S21 and S22.

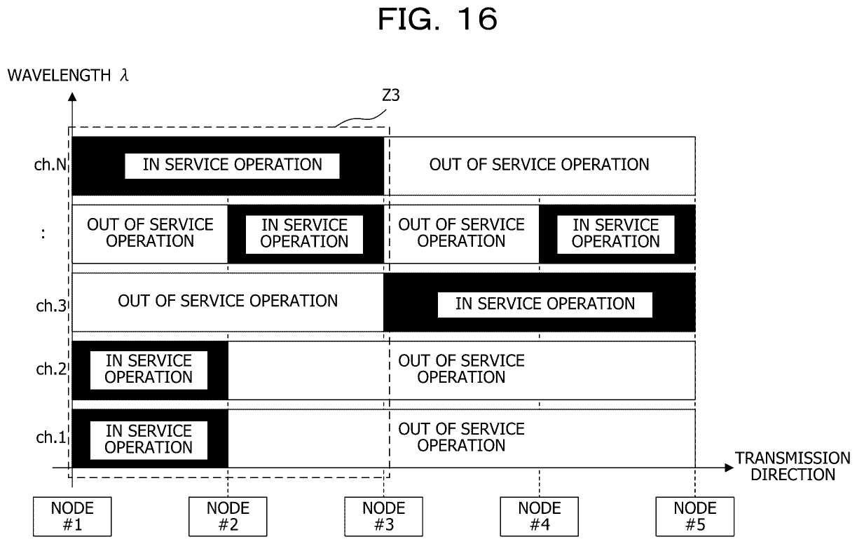

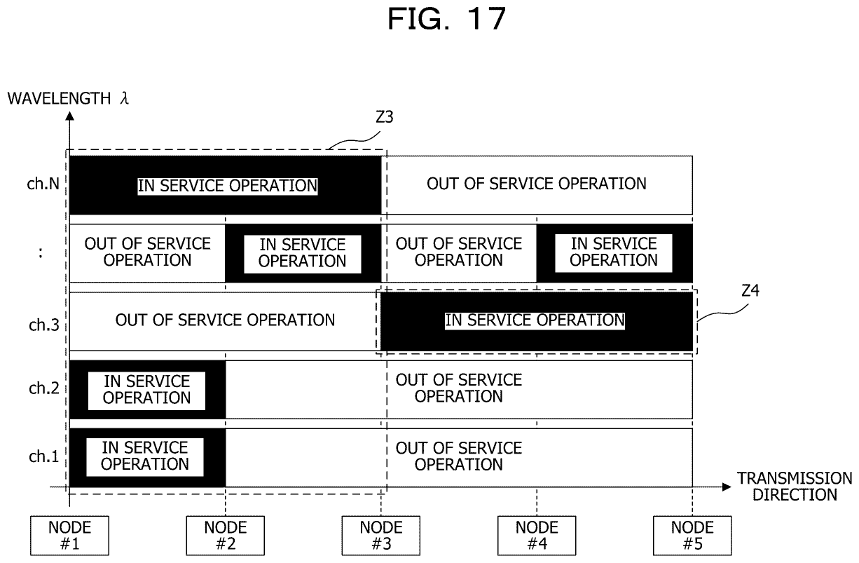

This ensures that, as illustrated in FIG. 16, for the separate section Z3 including the separate section Z1, the calculation unit 123 newly calculates a simple average of the above-described average value of the PMD values of the combined separate section and the PMD value of ch. N, as the average value of the PMD values of the common separate section. In addition, as illustrated in FIG. 17, the calculation unit 123 newly specifies, as a combined separate section, the separate sections Z3 and Z4 that do not have overlapping channels and are adjacent to each other as in-service operation sections. When specifying the combined separate section, the calculation unit 123 then calculates a square root of a sum of the square of the average value of the separate section Z3 and the square of the PMD value of the separate section Z4. The calculation unit 123 newly treats this calculated square root as the average value of the PMD values of the combined separate section.

Then, in a case where there is no separate sections that do not have overlapping channels and are adjacent to each other as in-service operation sections, the calculation unit 123 determines that there is no combinable section (step S23: YES). For example, as illustrated in FIG. 17, in a case where there is no combinable separate section that do not have an overlapping channel and is adjacent to the separate section Z4 as an in-service operation section, the calculation unit 123 determines that there is no combinable section. This specifies the average value of the PMD values from the node #1 to a node #5.

In a case where there is no combinable section, the calculation unit 123 determines whether or not there is an out-of-service operation section in a transmission direction (step S24). In the present embodiment, as illustrated in FIG. 17, there is the separate section Z4 representing an in-service operation section from a node #3 to the node #5. Therefore, the calculation unit 123 determines that there is no out-of-service operation section in the transmission direction (step S24: NO) and skips the processes in subsequent steps S25 to S27. This prompts the estimation unit 124 to execute the process in step S6.

If a node #6 adjacent to the node #5 is present in the transmission direction and the separate section from the node #5 to the node #6 is an out-of-service operation section, the calculation unit 123 determines that there is an out-of-service operation section in the transmission direction (step S24: YES). In this case, the acquisition unit 122 is not allowed to acquire the PMD value from the measuring instrument of the node #6 because the node #6 is in an out-of-service operation section.

Therefore, the acquisition unit 122 temporarily sets an optical path in the out-of-service operation section from the node #5 to the node #6, for example, in ch. 3 (step S25). This ensures that the node #6 receives signal light transmitted from the node #5, and thus, the acquisition unit 122 acquires the PMD value from the measuring instrument of the node #6 (step S26). When the PMD value is acquired, the calculation unit 123 then calculates the average value of the PMD values, based on the average value of the PMD values in the combined separate section from the node #1 to the node #5 calculated in the process in step S22 and the PMD value acquired in the process in step S26.

In this case, the calculation unit 123 calculates the average value of the PMD values by the square root of the sum of squares. When the average value of the PMD values is calculated, the estimation unit 124 then executes the process in step S6. As described above, according to the third embodiment, the optical network controller 100 may be sometimes allowed to estimate the worst value of the PMD values while avoiding the optical path setting described in the first embodiment. This may avoid, for example, the use of digital coherent receivers Rx and digital coherent transmitters Tx and may suppress short lives of the digital coherent receivers Rx and the digital coherent transmitters Tx. In addition, in a case where there is an out-of-service operation section in the transmission direction, the optical network controller 100 temporarily sets an optical path and calculates the average value of the PMD values, similarly to the first embodiment. This may allow the optical network controller 100 to estimate the worst value of the PMD values.

### Fourth Embodiment

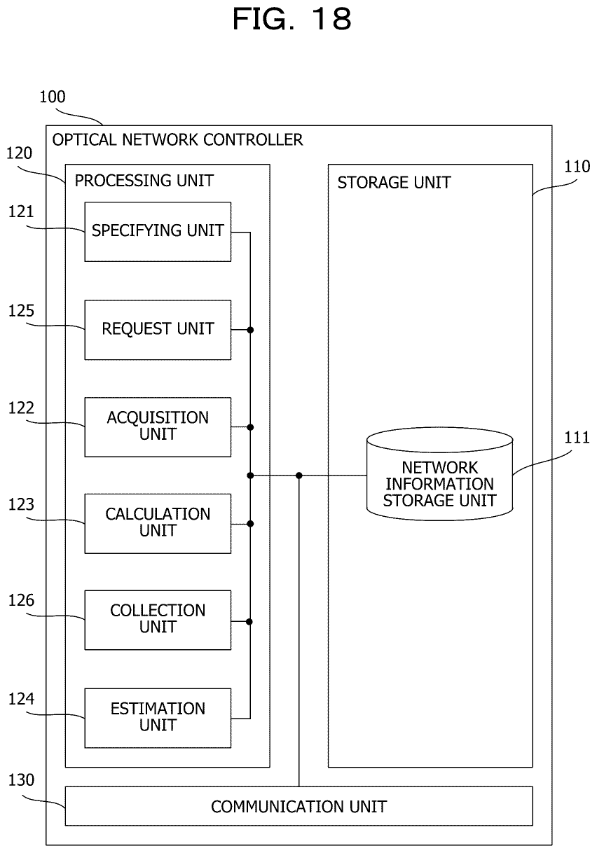

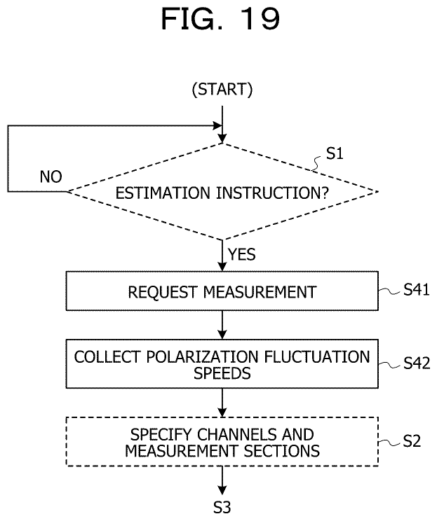

Subsequently, a fourth embodiment of the present case will be described with reference to FIGS. 18 and 19. An optical network controller 100 according to the fourth embodiment collects the polarization fluctuation speeds and calculates an average value of the PMD values, based on the collected polarization fluctuation speeds. By calculating the average value of the PMD values based on the polarization fluctuation speeds, the optical network controller 100 may improve the calculation accuracy for the average value of the PMD values.

First, as illustrated in FIG. 18, a processing unit 120 of the optical network controller 100 further includes a request unit 125 and a collection unit 126. When a specifying unit 121 detects the estimation instruction, the request unit 125 then requests a measuring instrument Mx (see FIG. 1) provided in, for example, an optical receiver R3 of a node #3 to measure the polarization fluctuation speed, as described in the first embodiment.

The collection unit 126 collects the polarization fluctuation speeds measured by the measuring instrument Mx and associates the collected polarization fluctuation speeds with the network information. For example, the collection unit 126 associates the polarization fluctuation speeds with the in-service operation sections for each channel. This allows the specifying unit 121 referring to the network information to determine whether or not polarization fluctuations have frequently occurred in the in-service operation sections through which the signal light propagates.

Here, as illustrated in FIG. 19, when the specifying unit 121 detects the estimation instruction in the process in step S1, the request unit 125 then requests for measurement of the polarization fluctuation speed (step S41). When requested to measure the polarization fluctuation speed, the measuring instrument Mx then measures the polarization fluctuation speed. This prompts the collection unit 126 to collect the polarization fluctuation speeds (step S42). When the polarization fluctuation speeds are collected, the specifying unit 121 then specifies the channels and the measurement sections by the process in step S2, based on the polarization fluctuation speeds associated with the network information by the collection unit 126.

For example, the specifying unit 121 determines, based on a polarization fluctuation amount, whether or not polarization fluctuations have frequently occurred in the in-service operation sections through which the signal light propagates. This polarization fluctuation amount may be an average value of polarization fluctuation speeds measured within a certain period of time, or may be an accumulated value of lengths of polarization fluctuation time measured within a certain period of time and having a polarization fluctuation speed equal to or more than a threshold speed.

If the polarization fluctuation amount exceeds a threshold fluctuation amount, the specifying unit 121 determines that polarization fluctuations have frequently occurred and specifies a channel and a measurement section having a polarization fluctuation amount exceeding the threshold fluctuation amount. If the calculation unit 123 calculates the average value of the PMD values, based on the channels and the measurement sections specified in this manner, the average value of the PMD values may be accurately calculated than in a case where polarization fluctuations have not frequently occurred. This may allow the optical network controller 100 to improve the estimation accuracy for the worst value of the PMD values.

### Fifth Embodiment

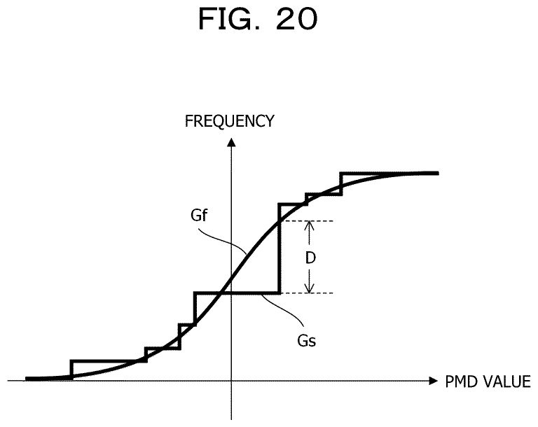

Subsequently, a fifth embodiment of the present case will be described with reference to FIG. 20. As described in the above-described embodiments, although an acquisition unit 122 acquires the PMD values, the PMD values may be unlikely to be in line with the Maxwell distribution, depending on the set of PMD values acquired by the acquisition unit 122. For example, in a case where the number of PMD values acquired by the acquisition unit 122 is small, the set of PMD values has a small amount, and thus, the PMD values may be unlikely to be in accordance with the Maxwell distribution. In this case, the optical network controller 100 may be unlikely to be allowed to accurately estimate the worst value of the PMD values, based on the Maxwell distribution.

Therefore, the acquisition unit 122 determines whether or not the set of PMD values is in line with the Maxwell distribution, using a goodness of fit test. In a case where the set of PMD values is not in line with the Maxwell distribution, the acquisition unit 122 may discard the PMD values, or may acquire the PMD values until the goodness of fit test is passed. Note that, as the goodness of fit test, for example, a known Kolmogorov-Smirnov test (K-S test) or the like can be used.

For example, as illustrated in FIG. 20, as a result of comparing a cumulative distribution function Gs of the PMD values acquired by the acquisition unit 122 with a cumulative distribution function Gf of the Maxwell distribution, there may be sometimes a significant maximum statistical difference D in a part between the cumulative distribution function Gs and the cumulative distribution function Gf. In such a case, the acquisition unit 122 acquires the PMD values until the K-S test is passed. This may allow a calculation unit 123 to accurately calculate the average value of the PMD values. As a result, an estimation unit 124 may accurately estimate the worst value of the PMD values.

### Sixth Embodiment

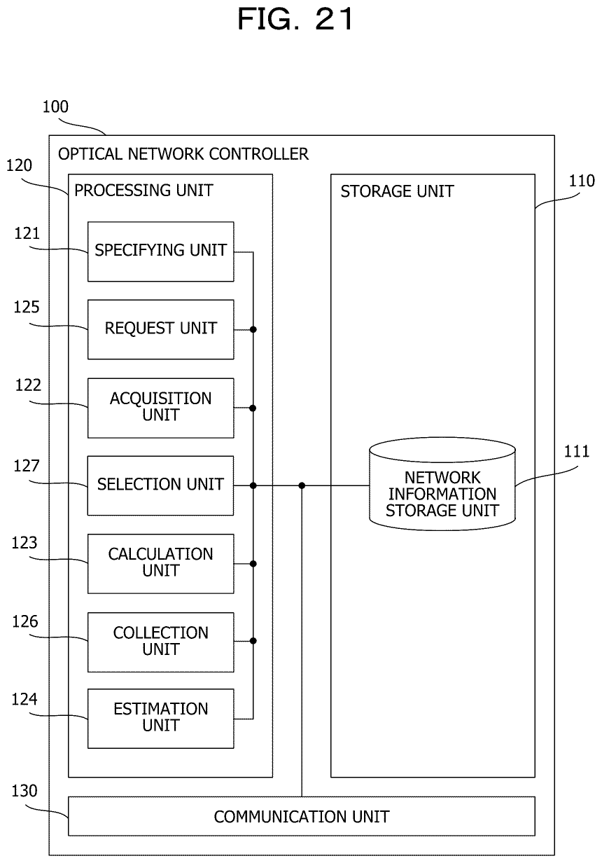

Subsequently, a sixth embodiment of the present case will be described with reference to FIGS. 21 to 23. An optical network controller 100 according to the sixth embodiment selects a signal type in terms of a modulation scheme, a baud rate, a transmission capacity, and the like, based on the worst value of the PMD values estimated in the first to fifth embodiments. As described in the first to fifth embodiments, the optical network controller 100 can estimate the worst value of the PMD values even when the in-service operation section and the out-of-service operation section are mixed. Therefore, the optical network controller 100 can select an appropriate signal type, based on the estimated worst value regardless of the design value of the PMD value.

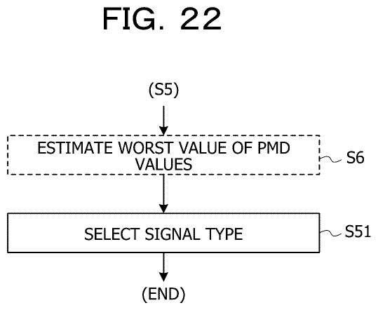

First, as illustrated in FIG. 21, a processing unit 120 of the optical network controller 100 further includes a selection unit 127. The selection unit 127 selects a signal type, based on the worst value of the PMD values estimated by an estimation unit 124. In addition, as illustrated in FIG. 22, when the estimation unit 124 estimates the worst value of the PMD values by the process in step S6, the selection unit 127 then selects a signal type (step S51) and ends the process.

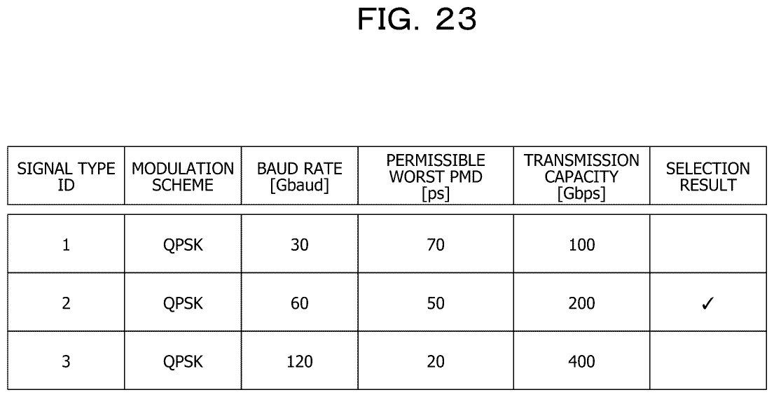

This may sometimes cause the estimation unit 124 to estimate 40 picoseconds (ps) as the worst value of the PMD values, for example, even in a case where the worst value of the PMD values permissible by design is deduced to be 70 ps, as illustrated in FIG. 23. In such a case, the selection unit 127 can select signal type identifiers (IDs) “1” and “2” of which the permissible worst values of the PMD values have 50 ps. At this time, the selection unit 127 desirably selects the signal type ID “2” that implements the maximum transmission capacity. Note that the selection unit 127 may select a combination of the modulation scheme, the baud rate, and the transmission capacity related to the signal type ID “2”, or may select at least one of these.

This may allow the optical network controller 100 to decrease the number of combinations of the digital coherent transmitter Tx and the digital coherent receiver Rx involved in transmitting and receiving the signal light from two to one, or from three to two, for example. As a result, the electric power consumed by the digital coherent transmitter Tx and the digital coherent receiver Rx may be reduced.

### Seventh Embodiment

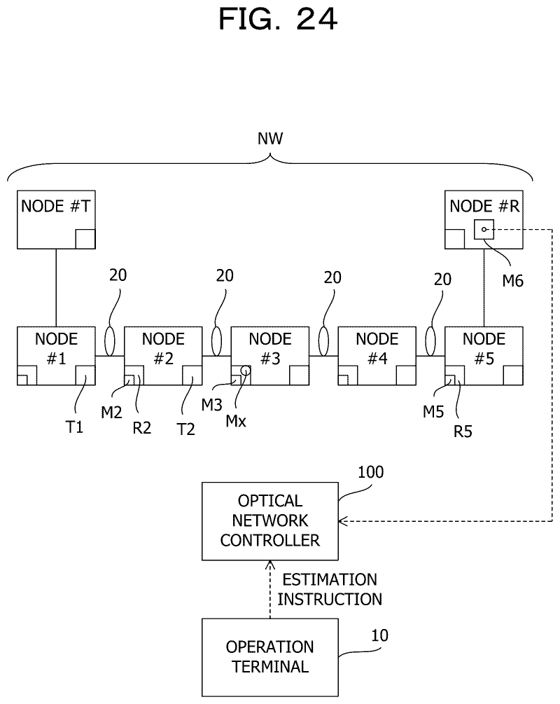

Subsequently, a seventh embodiment of the present case will be described with reference to FIGS. 24 to 28B. As illustrated in FIG. 24, an optical network NW includes a node #T, a plurality of nodes #1, . . . , and #5 described in the first embodiment, and a node #R. The node #T is an example of a transmission node and includes a transponder that transmits the signal light. The node #R is an example of a reception node and includes a transponder that receives the signal light. The node #T is arranged at one end of the optical network NW. The node #R is arranged at another end of the optical network NW. The nodes #1, . . . , and #5 are arranged as relay nodes between the node #T and the node #R.

The optical network controller 100 according to the seventh embodiment acquires, from the node #R, the Q factor of the signal light after propagating through an optical transmission path corresponding to the entire transmission section of the optical network NW from the one end to the another end and accumulates the acquired Q factor. The node #R includes a measuring instrument M6 that measures the pre-forward error correction bit error rate (PreFEC BER) and converts the measured PreFEC BER into the Q factor, based on a known conversion approach. Therefore, the optical network controller 100 can acquire and accumulate the Q factor from the measuring instrument M6.

When accumulating the Q factor, the optical network controller 100 then calculates a change amount ΔQ of the Q factor for a certain period and estimates a transmission penalty that fluctuates with time according to polarization characteristics such as the PMD or PDL, based on the change amount ΔQ. For example, the optical network controller 100 estimates an optical signal-to-noise ratio (OSNR) penalty that is an example of the transmission penalty, based on the change amount ΔQ and an OSNR-Q characteristic. Although details will be described later, the OSNR-Q characteristic is a graph representing a correlation between the Q factor and the OSNR.

Note that the Q factor is an example of a signal quality index, and the transmission penalty is an example of a characteristic value that fluctuates with time according to a polarization characteristic. The signal quality index is not limited to the Q factor and may be the pre-forward error correction bit error rate (PreFEC BER). The PreFEC BER is a bit error rate before forward error correction. For example, the optical network controller 100 may acquire the PreFEC BER and convert the acquired PreFEC BER into the Q factor, instead of the measuring instrument M6 converting the PreFEC BER into the Q factor.

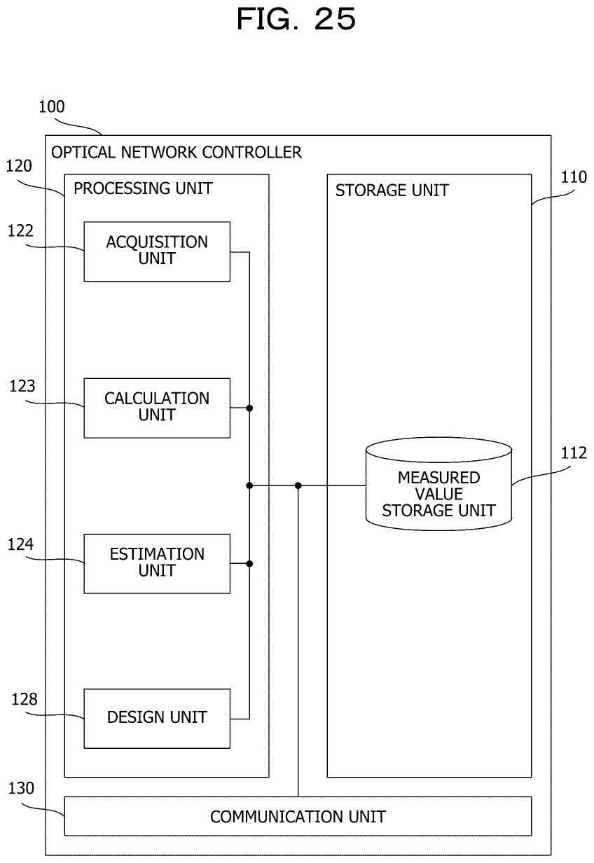

A functional configuration of the optical network controller 100 according to the seventh embodiment will be described with reference to FIG. 25. As illustrated in FIG. 25, a storage unit 110 includes a measured value storage unit 112. In addition, a processing unit 120 includes an acquisition unit 122, a calculation unit 123, an estimation unit 124, and a design unit 128.

The acquisition unit 122 acquires the Q factor from the measuring instrument M6 of the node #R. For example, the acquisition unit 122 acquires the Q factor over a long period of time such as several days or several months at regular intervals such as 15 minutes or one hour. When acquiring the Q factor, the acquisition unit 122 then saves the acquired Q factor in the measured value storage unit 112. This causes the measured value storage unit 112 to store the Q factor that changes in time series. In this manner, the optical network controller 100 accumulates time-series Q factor that changes with the passage of time.

Note that, in a case where the PreFEC BER is acquired from the measuring instrument M6, the acquisition unit 122 may convert the PreFEC BER into the Q factor, based on a known conversion approach, and save the Q factor in the measured value storage unit 112. As a known conversion approach, for example, the conversion approach disclosed in Japanese Laid-open Patent Publication No. 2018 082344 can be referred to.

The calculation unit 123 extracts the Q factor for a certain period (such as three days or one week, for example) from the measured value storage unit 112 and calculates the change amount ΔQ of the extracted Q factor for the certain period. Although details will be described later, when extracting the Q factor, the calculation unit 123 then generates distribution of the Q factor (for example, a frequency distribution table or a histogram) and calculates an average value of the Q factor. When calculating the average value of the Q factor, the calculation unit 123 then fits the average value of the Q factor to the Maxwell distribution (see FIG. 9) and calculates the worst value of the Q factor, as the change amount ΔQ of the Q factor. In this manner, in a case where the Q factor changes with time, its statistical distribution (probability density distribution) can be theoretically approximated to the Maxwell distribution.

The estimation unit 124 estimates the transmission penalty, based on the change amount ΔQ calculated by the calculation unit 123. As described above, the estimation unit 124 estimates the OSNR penalty according to the change amount ΔQ, based on the change amount ΔQ and the OSNR-Q characteristic. When estimating the OSNR penalty, the estimation unit 124 then applies the OSNR penalty to the design unit 128. In this manner, the estimation unit 124 estimates the OSNR penalty attributable to polarization characteristics, using the Q factor, without using the polarization characteristic value (for example, the PMD value or the PDL value) having a large measurement error. This may improve the estimation accuracy for the OSNR penalty as compared with a case of using the polarization characteristic value.

The design unit 128 computes reachability of the signal light, based on the input power of the signal light input to the node #R, power loss (hereinafter, referred to as span loss) of the signal light occurring in the section, for example, from the node #4 to the node #5, and the like. The input power is an example of a power index, and the span loss is an example of a loss index. For example, the design unit 128 deduces the OSNR and the transmission penalty for each time, based on the input power and the span loss at each time, and simulates the Q factor of the signal light at each time after being transmitted through the optical network NW. The transmission penalty deduced by the design unit 128 includes a penalty attributable wavelength dispersion, or the like, for example, apart from a PDL penalty attributable to the PDL and a PMD penalty attributable to the PMD.

Here, when simulating the Q factor, the design unit 128 may simulate the Q factor including a network topology of the optical network NW, a span length, performance information on each device such as the node #T, the node #R, and the nodes #1, . . . , and #5, and the like. When simulating the Q factor at each time, the design unit 128 then outputs the simulated Q factor at each time to the calculation unit 123. This ensures that the calculation unit 123 calculates a temporal difference of the Q factor at each time, as a correction value for the Q factor. The correction value for the Q factor is an example of a signal quality change amount and corresponds to an impact amount on the Q factor that the input power and the span loss have. The calculation unit 123 calculates a new Q factor obtained by removing the correction value for the Q factor from the Q factor as an actual measured value acquired by the acquisition unit 122, as a corrected Q factor. The corrected Q factor is an example of a new signal quality index. Note that the calculation unit 123 may separately calculate the impact amount on the Q factor that the input power has and the impact amount on the Q factor that the span loss has, each as the signal quality change amount.

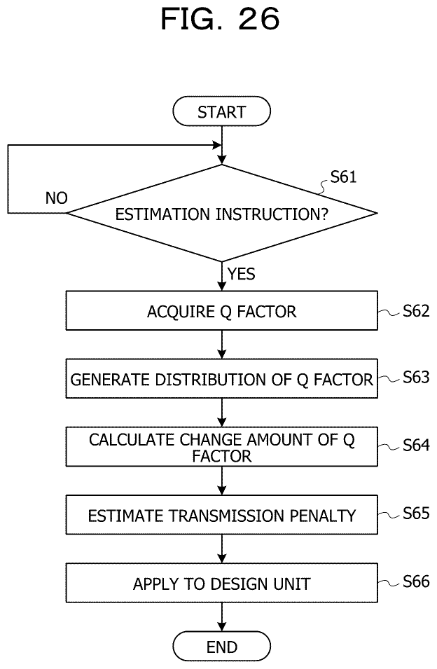

An action of the optical network controller 100 according to the seventh embodiment will be described with reference to FIGS. 26 to 28B.

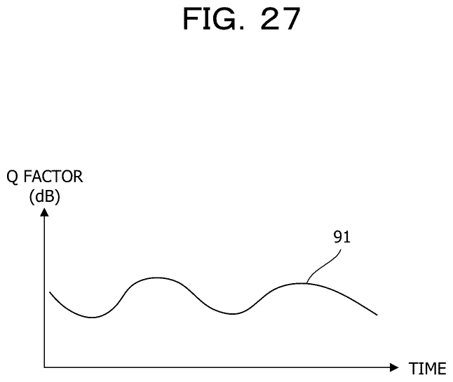

First, as illustrated in FIG. 26, the acquisition unit 122 waits until an estimation instruction is detected (step S61: NO). The estimation instruction is an instruction intended to request the optical network controller 100 to estimate the transmission penalty. When detecting the estimation instruction (step S61: YES), the acquisition unit 122 then acquires the Q factor (step S62). For example, the acquisition unit 122 periodically acquires the Q factor at regular intervals of 15 minutes or 60 minutes. When acquiring the Q factor, the acquisition unit 122 then saves the acquired Q factor in the measured value storage unit 112. This ensures that, as illustrated in FIG. 27, the measured value storage unit 112 stores a time-series Q factor 91 that changes with the passage of time.

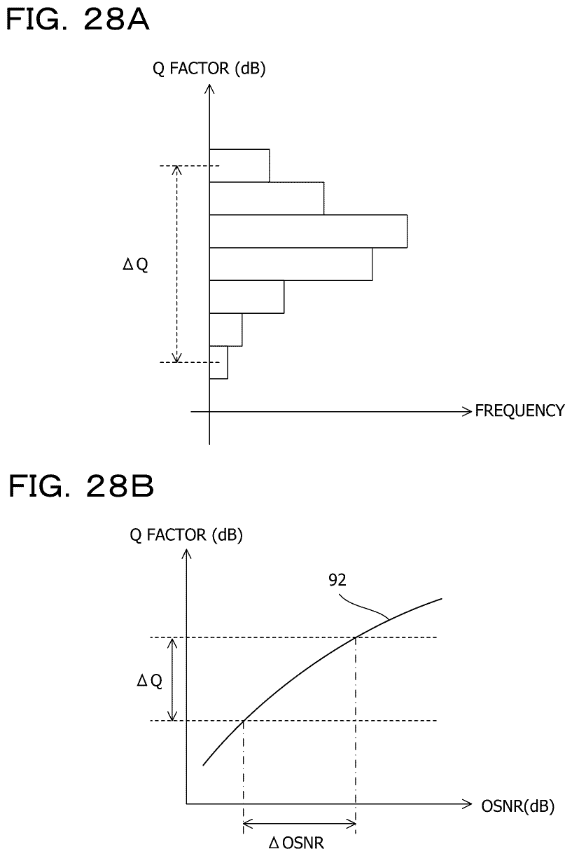

When the acquisition unit 122 acquires the Q factor and saves the acquired Q factor in the measured value storage unit 112, the calculation unit 123 then generates distribution of the Q factor (step S63). For example, the calculation unit 123 extracts the Q factor for a certain period from the measured value storage unit 112 and generates distribution of the Q factor, as illustrated in FIG. 28A.

When generating the distribution of the Q factor, the calculation unit 123 then calculates the change amount ΔQ of the Q factor (step S64). For example, the calculation unit 123 calculates an average value of the Q factor, based on the distribution of the Q factor, calculates the worst value of the Q factor by fitting the average value of the Q factor to the Maxwell distribution, and specifies the worst value of the Q factor as the change amount ΔQ of the Q factor, as illustrated in FIG. 28A.

When the calculation unit 123 calculates the change amount ΔQ of the Q factor, the estimation unit 124 then estimates the transmission penalty (step S65). For example, as illustrated in FIG. 28B, the estimation unit 124 estimates an OSNR penalty ΔOSNR according to the change amount ΔQ, as the transmission penalty, based on the change amount ΔQ of the Q factor calculated by the calculation unit 123 and an OSNR-Q characteristic 92. In this manner, the transmission penalty of the signal quality attributable to polarization characteristics fluctuates due to a temporal change in a polarization state and appears as a change in the Q factor. Therefore, the estimation unit 124 can estimate the transmission penalty by measuring the Q factor and calculating back from the change in the Q factor.

When estimating the transmission penalty, the estimation unit 124 then applies the transmission penalty to the design unit 128 (step S66) and ends a series of processes. As described above, the design unit 128 deduces the PDL penalty or the PMD penalty, but the estimation unit 124 alters the PDL penalty or the PMD penalty to the transmission penalty. This may allow the design unit 128 to simulate the Q factor in the next reachability computation, based on the transmission penalty estimated by the estimation unit 124.

Accordingly, the transmission penalty according to the present embodiment is suppressed to half or less, as compared with the transmission penalty as a fixed value designed with reference to specification standards or the transmission penalty dynamically estimated based on the polarization characteristic value such as the PMD value or the PDL value. As described above, in the present embodiment, since the accuracy of the transmission penalty is improved, a useless margin for securing the transmission quality may be cut down.

### Eighth Embodiment

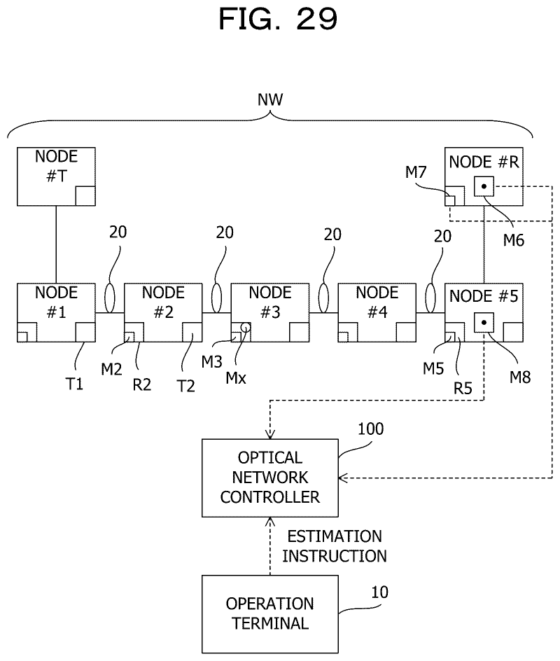

Subsequently, an eighth embodiment of the present case will be described with reference to FIGS. 29 to 32C. Note that, in FIG. 29, the same components as those of the optical network NW described with reference to FIG. 24 are given the same reference signs, and a detailed description thereof will be omitted.

First, as illustrated in FIG. 29, a node #R includes a measuring instrument M7 that measures the input power of signal light input to the node #R, as well as a measuring instrument M6. The measuring instrument M7 measures the input power in synchronization with the measurement of the PreFEC BER by the measuring instrument M6. An optical network controller 100 can acquire and accumulate the input power from the measuring instrument M7. In addition, a node #5 includes a measuring instrument M8 that measures span loss occurring in the section from a node #4 to the node #5. The measuring instrument M8 measures the span loss in synchronization with the measurement of the PreFEC BER by the measuring instrument M6. The optical network controller 100 can acquire and accumulate the span loss from the measuring instrument M8.

Note that, although not illustrated, each of a node #1 to a node #4 may include a measuring instrument that measures span loss, similarly to the node #5. In this case, the optical network controller 100 can acquire and accumulate the span loss from each of the measuring instruments of the node #1 to the node #4.

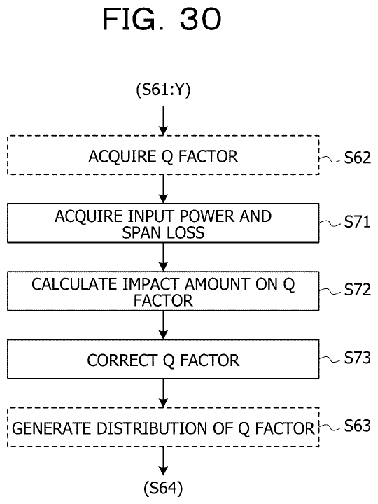

Subsequently, an action of the optical network controller 100 according to the eighth embodiment will be described with reference to FIGS. 30 to 32C. Note that, in FIG. 30, some processes overlapping with the flowchart illustrated in FIG. 26 are omitted.

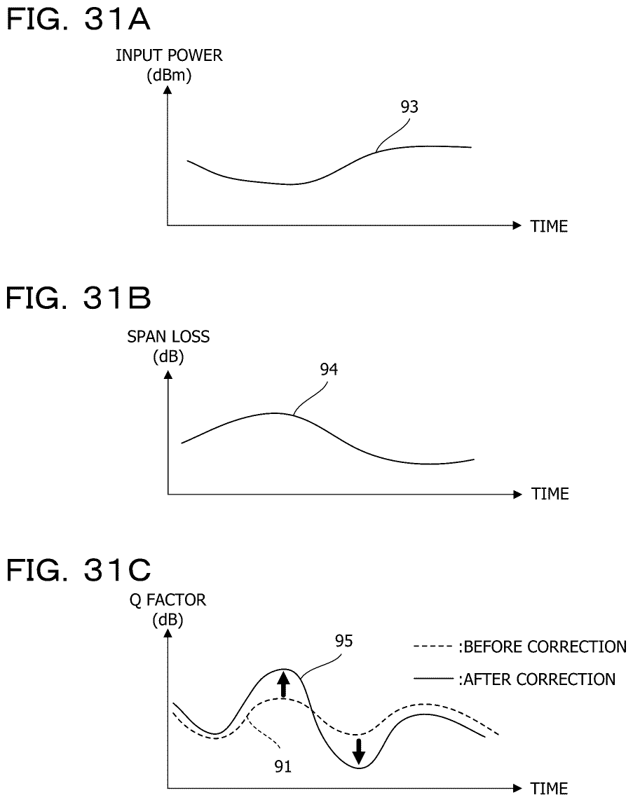

As illustrated in FIG. 30, when ending the process in step S62, the acquisition unit 122 then acquires the input power and the span loss (step S71). For example, similarly to the acquisition of the Q factor, the acquisition unit 122 acquires the optical power from the measuring instrument M7 of the node #R and acquires the span loss from the measuring instrument M8 of the node #5. When acquiring the input power and the span loss, the acquisition unit 122 then saves the acquired input power and span loss in a measured value storage unit 112. This ensures that, as illustrated in FIG. 31A, the measured value storage unit 112 stores time-series input power 93 that changes with the passage of time. In addition, as illustrated in FIG. 31B, the measured value storage unit 112 stores time-series span loss 94 that changes with the passage of time.

When the acquisition unit 122 acquires the input power and the span loss and saves the acquired input power and span loss in the measured value storage unit 112, a calculation unit 123 then calculates an impact amount on the Q factor (step S72). For example, the calculation unit 123 extracts the Q factor, the input power, and the span loss for a certain period from the measured value storage unit 112 and outputs the extracted Q factor, input power, and span loss to a design unit 128 for each time. This prompts the design unit 128 to simulate the Q factor of the signal light at each time after being transmitted through the optical network NW, based on the input power and the span loss. When simulating the Q factor at each time, the design unit 128 then outputs this Q factor at each time to the calculation unit 123. This prompts the calculation unit 123 to calculate the impact amount on the Q factor by the input power and the span loss, by calculating a temporal difference of the Q factor at each time, as the correction value for the Q factor.

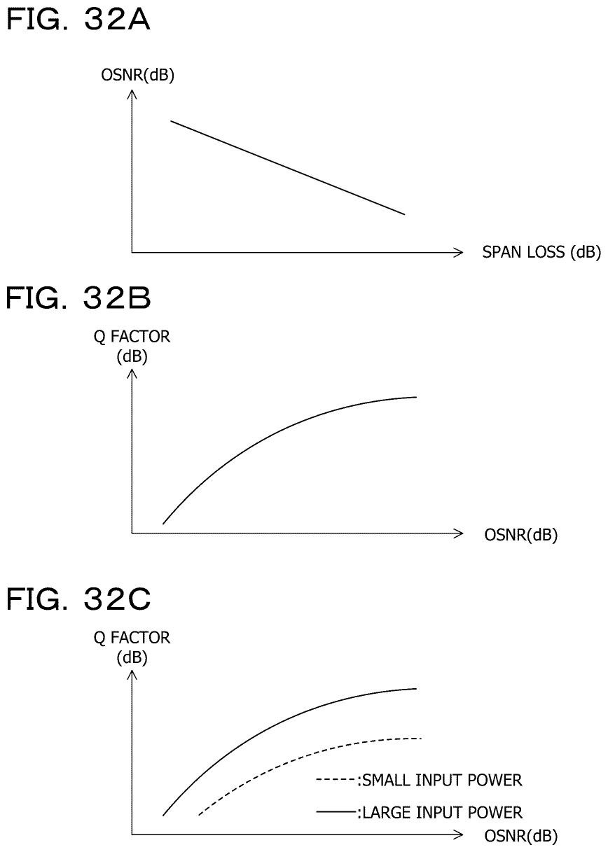

Here, for example, as illustrated in FIG. 32A, when the span loss changes, the OSNR changes according to the change in the span loss. For example, as the span loss increases, the OSNR lowers. Conversely, as the span loss lowers, the OSNR increases. As the OSNR increases, the Q factor increases as illustrated in FIG. 32B. In addition, as illustrated in FIG. 32C, when the input power of the signal light to the node #R is small, the performance of the node #R lowers as compared with a case where the input power is large, and thus the Q factor lowers. In this manner, the change in the span loss and the input power appear as a change in the Q factor.

When calculating the impact amount on the Q factor, the calculation unit 123 then corrects the Q factor (step S73). For example, the calculation unit 123 corrects the Q factor by removing the impact amount on the Q factor from the Q factor as an actual measured value. By removing the impact amount on the Q factor from the Q factor as an actual measured value, as illustrated in FIG. 31C, a time-series Q factor 91 before the correction changes to a corrected time series Q factor 95. The impact amount of the change in the input power and the span loss has been removed from the corrected time series Q factor 95. When correcting the Q factor, the calculation unit 123 then generates distribution of the corrected Q factor by the processes in steps S63 and S64 and calculates a change amount ΔQ of the corrected Q factor. Thereafter, an estimation unit 124 estimates the transmission penalty, based on the change amount ΔQ of the corrected Q factor.

As described above, in the eighth embodiment, the calculation unit 123 corrects the Q factor, based on the impact amount on the Q factor that, for example, the input power and the span loss have. For example, the calculation unit 123 corrects the Q factor by removing the impact amount on the Q factor from the Q factor as an actual measured value. Then, the calculation unit 123 calculates the change amount ΔQ, based on the corrected Q factor, and the estimation unit 124 estimates the transmission penalty, based on this change amount ΔQ. As described above, since the transmission penalty is estimated based on the corrected Q factor, the estimation accuracy for the transmission penalty may be improved as compared with the case of the seventh embodiment.

While the preferred embodiments have been described in detail thus far, the embodiments are not limited to particular embodiments, and various modifications and alterations can be made within the scope of the present embodiments described in the claims.

For example, in a case where a change in the operation state is detected, such as an increase or decrease in the number of wavelengths in an optical communication service using a plurality of wavelengths provided by the optical network NW, the acquisition unit 122 may discard the Q factor that has already been acquired and re-acquire the Q factor. This avoids the impact on the Q factor caused by the change in the operation state, and the transmission penalty is accurately estimated. In addition, in a case where such a change in the operation state is detected, the acquisition unit 122 may calculate a difference in the Q factor before and after the change in the operation state and correct the Q factor that has already been acquired, based on the difference. Even with such a configuration, the impact on the Q factor caused by a change in the operation state is avoided, and the transmission penalty is accurately estimated.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An optical transmission path characteristic estimation device that estimates a polarization characteristic value of an optical path in which first sections that are in service operation of an optical communication service that uses a plurality of wavelengths and second sections that are out of the service operation are mixed, the optical transmission path characteristic estimation device comprising:
a memory; and
a processor coupled to the memory and configured to
acquire first polarization characteristic values for each of the plurality of wavelengths in the first sections, and acquires second polarization characteristic values for each of the plurality of wavelengths in the second sections, based on information that represent an operation state of the optical communication service, and
calculate wavelength-specific polarization characteristic values of the optical path for each of the plurality of wavelengths, based on the first polarization characteristic values and the second polarization characteristic values.

2. The optical transmission path characteristic estimation device according to claim 1, wherein the processor calculates a polarization characteristic average value that is an average value of the wavelength-specific polarization characteristic values, based on a total sum of the wavelength-specific polarization characteristic values and a number of wavelengths of the plurality of wavelengths.

3. The optical transmission path characteristic estimation device according to claim 2, the processor further configured to estimate a limit value of the polarization characteristic value of the optical path, as a constant multiple of the polarization characteristic average value, based on Maxwell distribution in which an occurrence probability of the limit value is fixed, and the polarization characteristic average value.

4. The optical transmission path characteristic estimation device according to claim 1, the processor further configured to
count a number of the second sections in the optical path for each of the wavelengths, and
specify a part of the plurality of wavelengths in ascending order of the number until matching a threshold bandwidth, wherein the processor acquires the first polarization characteristic values of the first sections according to the part of the plurality of wavelengths.

5. The optical transmission path characteristic estimation device according to claim 2, the processor further configured to
collect a speed of a polarization fluctuation that occurs in the first sections, and
specify the first sections in which a polarization fluctuation amount according to the speed of the polarization fluctuation exceeds a threshold fluctuation amount, and a part of the plurality of wavelengths, wherein the processor acquires the first polarization characteristic values of the part of the plurality of wavelengths in the first sections, and the second polarization characteristic values, and calculates the polarization characteristic average value, based on the first polarization characteristic values and the second polarization characteristic values.

6. The optical transmission path characteristic estimation device according to claim 3, wherein the processor determines whether or not a set of the first polarization characteristic values is in line with a cumulative distribution function of the Maxwell distribution, based on a goodness of fit test, and when the set is not in line with the cumulative distribution function, acquires the first polarization characteristic values until the goodness of fit test is met.

7. The optical transmission path characteristic estimation device according to claim 3, the processor further configured to select a signal type of signal light that uses the plurality of wavelengths, based on the limit value.

8. An optical transmission path characteristic estimation device that estimates a polarization characteristic value of an optical path in which first sections that are in service operation of an optical communication service that uses a plurality of wavelengths and second sections that are out of the service operation are mixed, the optical transmission path characteristic estimation device comprising:
a memory; and
a processor coupled to the memory and configured to
acquire first polarization characteristic values for each of the plurality of wavelengths in the first sections, based on information that represents an operation state of the optical communication service,
calculate a first polarization characteristic average value that is an average value of the first polarization characteristic values, based on the first polarization characteristic values common to the first sections, and calculates a second polarization characteristic average value that is the average value of the first polarization characteristic values in a combined section obtained by combining the first sections that are adjacent to each other, based on the first polarization characteristic values and the first polarization characteristic average values of the combined section, and
when there is none of the second sections adjacent to the combined section in a transmission direction of signal light that includes any of the plurality of wavelengths, estimate a limit value of the polarization characteristic value of the optical path, as a constant multiple of the second polarization characteristic average value, based on Maxwell distribution in which an occurrence probability of the limit value is fixed, and the second polarization characteristic average value.

9. An optical transmission path characteristic estimation device that estimates a characteristic value that fluctuates with time according to a polarization characteristic of an optical transmission path that includes a plurality of nodes arranged from one end to another end of an optical network, the optical transmission path characteristic estimation device comprising:
a memory; and
a processor coupled to the memory and configured to
acquire signal quality indices of signal light after propagating through the optical transmission path, from a reception node arranged at the another end of the optical network,
calculate a quality change amount of the signal quality indices for a certain period, and
estimate the characteristic value, based on the quality change amount.

10. The optical transmission path characteristic estimation device according to claim 9, wherein the processor calculates the quality change amount, based on an average value of the signal quality indices, and Maxwell distribution.

11. The optical transmission path characteristic estimation device according to claim 9, wherein, when detecting a change in an operation state that includes an increase or a decrease in a number of wavelengths in an optical communication service that uses a plurality of the wavelengths provided in the optical network, the processor discards the signal quality indices that have already been acquired, and re-acquires the signal quality indices.

12. The optical transmission path characteristic estimation device according to claim 9, wherein, when detecting a change in an operation state that includes an increase or a decrease in a number of wavelengths in an optical communication service that uses a plurality of the wavelengths provided in the optical network, the processor calculates a difference between the signal quality indices before and after the change in the operation state, and corrects the signal quality indices that have already been acquired, based on the difference.

13. The optical transmission path characteristic estimation device according to claim 9, wherein the processor acquires, from a first relay node arranged between the one end and the another end of the optical network, a loss index that represents power loss of the signal light that occurs in a section from a second relay node arranged upstream of the first relay node to the first relay node, calculates a new signal quality index obtained by excluding a signal quality change amount calculated based on the loss index for the certain period from the signal quality indices, and estimates the characteristic value, based on the new signal quality index.

14. The optical transmission path characteristic estimation device according to claim 9, wherein processor acquires, from the reception node, a power index that represents input power of the signal light input to the reception node, calculates a new signal quality index by excluding a signal quality change amount calculated based on the power index for the certain period from the signal quality indices, and estimates the characteristic value, based on the new signal quality index.

15. The optical transmission path characteristic estimation device according to claim 9, wherein the processor acquires, from a first relay node arranged between the one end and the another end of the optical network, a loss index that represents power loss of the signal light that occur in a section from a second relay node arranged upstream of the first relay node to the first relay node, acquires, from the reception node, a power index that represents input power of the signal light input to the reception node, calculates a new signal quality index obtained by excluding, from the signal quality indices, a signal quality change amount calculated based on the loss index for the certain period and a signal quality change amount calculated based on the power index for the certain period, and estimates the characteristic value, based on the new signal quality index.

16. The optical transmission path characteristic estimation device according to claim 9, wherein the signal quality indices include one of a quality (Q) factor of the signal light or a pre-error correction bit error rate of the signal light.
